(19) United States
(12) Patent Application Publication
(10) Pub. No.: US 2007/0076706 A1
(43) Pub. Date: Apr. 5, 2007

(54) Fast reroute in a multiprotocol label switching network

(75) Inventor: Dekel Shirizly, Pardes Hana (IL)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 11/240,592

(22) Filed: Sep. 30, 2005

(51) Int. Cl. H04L 12/56

(52) U.S. Cl. 370/389; 370/400

(57) ABSTRACT

A fast reroute in a multiprotocol label switching network is provided. According to one embodiment, a method for finding a Label Switch Path (LSP) in a Multiprotocol Label Switching (MPLS) network device is provided. The method comprising retrieving a packet from an receive port having an identifier, searching an improved routing table having an incoming information and an outgoing information for the incoming information having an incoming port identifier that matches the identifier, retrieving the incoming internal index and the outgoing port identifier from the matching incoming information, retrieving a status for the second port identifier from a port status table; and applying an function between the incoming internal index and status forming a derived index.

### FIELD OF THE INVENTION

The present invention relates to a communications network, and more particularly, to a fast reroute to backup Label Switch Paths in a Multiprotocol Label Switching network.

### BACKGROUND

Multiprotocol Label Switching (MPLS) is an architecture for fast packet switching and routing and is used in communications networks. MPLS is called multiprotocol since it is independent of layer-2 and layer-3 protocols such as Asynchronous Transport Mode (ATM), frame relay, and Internet Protocol (IP).

The MPLS network includes an Ingress Label Edge Router (LER), an Egress LER, and a Label Switch Router (LSR). The Ingress LER receives a packet, such as an IP packet, to which the LER adds an MPLS header and assigns a label. The packet is transmitted through a pre-configured path via routing tables. Each leg of the pre-configured path is called a Label Switched Path (LSP). The Egress LER removes the MPLS header and may forward the packet based on the protocol of the packet, e.g. IP.

Sometimes a failure occurs in the pre-configured path. In which case the routing tables are update.

There exists a need to provide an improved way to reroute to backup LSPs.

### SUMMARY OF THE INVENTION

In one aspect of the present invention, a method for finding an Label Switch Path (LSP) in a Multiprotocol Label Switching (MPLS) network device is provided. The method comprising receiving a packet from an receive port having an identifier, searching an improved routing table having an incoming information and an outgoing information for the incoming information having an incoming port identifier that matches the identifier, retrieving the incoming internal index and the second port identifier from the matching incoming information, retrieving a status for the second port identifier from a port status table, and applying an function between the incoming internal index and status forming a derived index.

In another aspect of the present invention a device in a Multiprotocol Label Switching (MPLS) network device having a fast reroute is provided. The device comprising a first memory unit, an improved routing table stored in the first memory unit, a port status table having a status in the first memory unit, an incoming port, which has an identifier, receiving a packet, an incoming mechanism operable and a function. The improved routing table comprising an incoming information including a first port identifier, an incoming internal index, and a second port identifier, and an outgoing information including an outgoing internal index, and a third port identifier. The incoming mechanism operable to search the improved routing table for the incoming information having the incoming port that matches the identifier, retrieve the incoming internal index and the second port identifier for the matching incoming information, and retrieve the status for the second port identifier. The function applied between the incoming internal index and status forming a derived index.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the invention. The drawings contain the following figures, in which like numbers refer to like parts throughout the description and drawings wherein:

FIG. 1 illustrates an exemplary prior art schematic diagram of a Multiprotocol Label Switching (MPLS) network;

FIG. 2 illustrates an exemplary prior art diagram of a route table in a communications network;

FIG. 3 illustrates an exemplary diagram of a port status table in accordance with the present invention;

FIG. 4 illustrates an exemplary diagram of a route table in accordance with the present invention;

FIG. 5 illustrates an exemplary flow diagram for routing a packet in accordance with the present invention;

FIG. 6 illustrates an exemplary diagram of a calculation of a derived index in accordance with the present invention; and

FIG. 7 illustrates an exemplary schematic diagram of a device having a fast reroute in accordance with the present invention.

### DETAILED DESCRIPTION OF THE INVENTION

The invention described herein may employ one or more of the following concepts. For example, one concept relates to providing a normal LSP for a Multiprotocol Label Switching (MPLS) network. Another concept relates to providing a reroute LSP for a MPLS network. Still another concept relates to applying a function between an internal index and a port status to calculate a derived index. Yet another concept relates to the derived index determining the LSP.

The present invention is disclosed in context of an IP packet being transmitted in an MPLS network. The principles of this invention, however, are not limited to an IP packet but may be applied to other packet types over the MPLS communications network, such as Asynchronous Transfer Mode (ATM) packets. Furthermore, the present invention is not limited to an MPLS communications network but may be applied to any routing architecture having a label, tag, and the like. The present invention is disclosed in terms of a port status table being a bit vector, which is an array of bits, wherein a single bit status provides one reroute LSP. However, the principles of this invention may be applied to a port status table in a format other than a bit vector such as an array of 2 bits, wherein the status may provide for 3 reroute LSPs. Furthermore, the port status table does not have to be in an array format but any format that allows a status in the table to be changed and or retrieved. While the present invention is described in terms of an LSP the principles of the present invention may be applied to routing paths such as LSP tunnels.

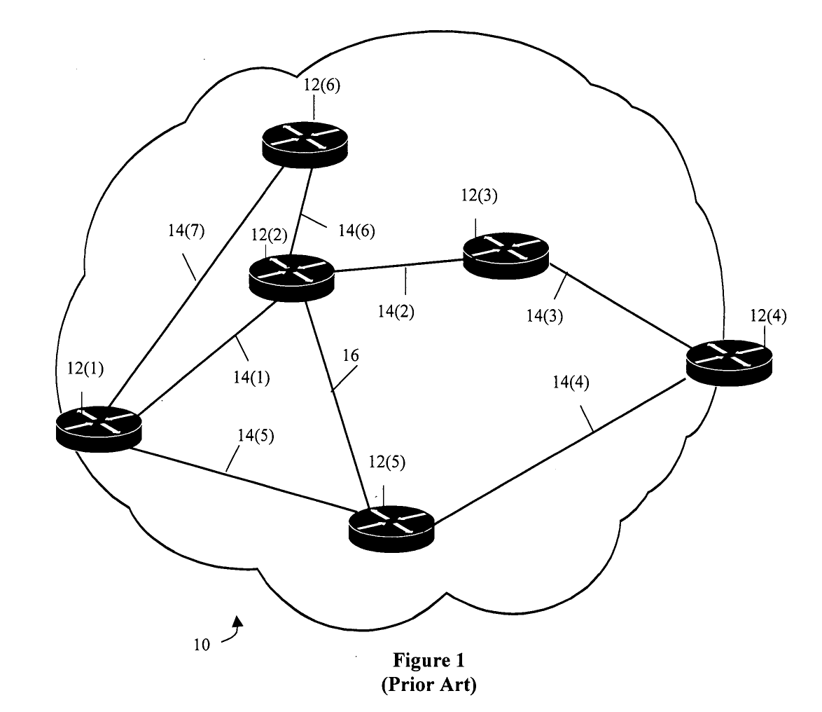

Referring to FIG. 1, an exemplary prior art schematic diagram of a MPLS network 10 is provided. The MPLS network 10 includes a plurality of nodes 12, a plurality of Label Switched Paths (LSPs) 14, and a reroute LSP 16. The nodes 12 include an Ingress Label Edge Router (LER) 12(1), an Egress LER 12(4), and a plurality of Label Switch Routers (LSRs) 12(2), 12(3), 12(5), 12(6). An IP packet may enter the MPLS communications network 10 at the Ingress LER 12(1) and be routed via routing tables over the pre-configured path LSP 14(1), LSP 14(2), LSP 14(3), wherein each node 12 has a routing table. If however, a LSP 14 fails along the pre-configured path the routing table must be reconfigured so that the packet may be rerouted. For example, if LSP 14(2) fails, the reroute LSP 16 may be used between LSR 12(2) and LSR 12(4)

Those skilled in the art would realize that the exemplary illustration of FIG. 1 is a simplified illustration of an MPLS communications network 10 and that a typical MPLS communications network 10 may include additional nodes 12, LSPs 14, and reroute LSPs 16.

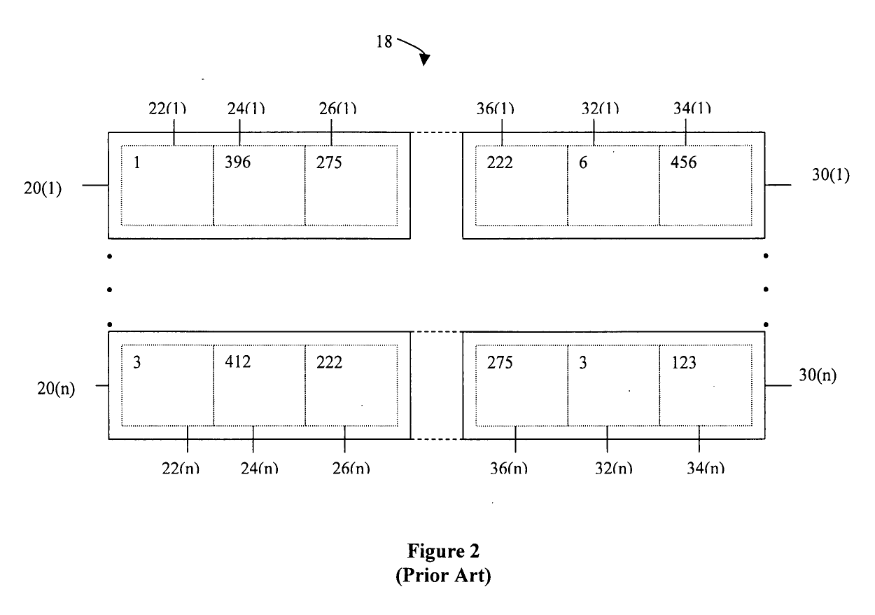

Referring now to FIGS. 1 and 2, an exemplary prior art diagram of a routing table 18 is provided. The routing table 18 includes n number of the incoming routing information 20 and includes n number of the outgoing routing information 30.

The incoming routing information 20 may include an incoming port identifier 22, an incoming internal index 26, and an incoming label 24. The outgoing routing information 30 may include an outgoing internal index 36, an outgoing port identifier 32, and an outgoing label 34.

The incoming port identifier 22 corresponds to port having received a packet from a device. The device may be the node 12 in the MPLS communication network 10. For the Ingress LER 12(1), however, the device is typically outside the MPLS communication network 10.

The incoming label 24 corresponds to a label in a packet received by the LSR 12(2), 12(3), 12(5), 12(6) and the Egress LSR 12((3). Packets received by the Ingress LER 12(1) do not have a label so the incoming label 24 does not apply to the Ingress LER 12(1).

The incoming internal index 26 may be, for example, an administrable or configurable value. The incoming internal index 26 is used to associate an incoming routing information 20 with and outgoing routing information 30. The incoming routing information 20 is associated with the outgoing routing information 30 when the incoming internal index 26 matches the outgoing internal index 36. The outgoing internal index 36 may be, for example, an administrable or configurable value.

The outgoing port identifier 32 corresponds to a port via a packet is to a device. The device may be the node 12 in the MPLS communication network 10. For the Egress LER 12(4), however, the device is typically outside the MPLS communication network.

The outgoing label 34 corresponds to a label indicating a path, which corresponds to a LSP 14. The outgoing label 34 is included in the packet to be sent by the LSR 12(2), 12(3), 12(5), 12(6) and the Ingress LER 12((1). Packets sent by the Egress LER 12(4) do not have a label so the outgoing label 34 does not apply to the Egress LER 12(4).

The routing table, as illustrated in FIG. 2, is used in the LSR 12(2). When the node 12(2) receives a packet from a device, the routing table 18 is searched for the incoming routing information 20 having the incoming port identifier 22, which corresponds to the device, and having an incoming label 24 that matches a label in the received packet. Using the incoming internal index 36 from the incoming routing information 20, an associated outgoing routing information 30 is identified. The outgoing label 34 is included in the packet sent to the subsequent node 12.

If the LSR 12(2) received a packet having a label of 396 from node 12(1) connected to a port having an identifier of 1, a match would be made on the incoming routing information 20(1), since the incoming routing information 20(1) has an incoming port identifier 22 of 1 and an incoming label 22(1) of 396. The outgoing routing information 30(n) is associated to incoming routing information 20(1) since they both have indexes 26(1), 36(1) of 275. The packet sent by LSR 12(2) would include the outgoing label 30(n) of 123 and be sent to port 3, which for this example corresponding to node 12(3).

If for any reason the LSP 14(2) becomes disabled, the nodes 12 should update their routing table 18. In the prior, art this is typically done by scanning the entire routing table 18 to find all the paths that are configured on the disabled LSP 14(2) and update the routing table 18. The routing table 18 is updated by changing index 26 and/or index 36, so that the reroute LSP 16 is used. This technique, however, uses a lot of processing, especially as the size of the routing table 18 increases. For example, a routing table 18 that support 128K internal indexes 26 may take 1/10 second to update the routing table 18 to indicate routine on the reroute LSP 16. Furthermore, when the LSP 14(2) is no longer disabled, the routing table 18 would be updated to indicate routing on the normal LSP 14.

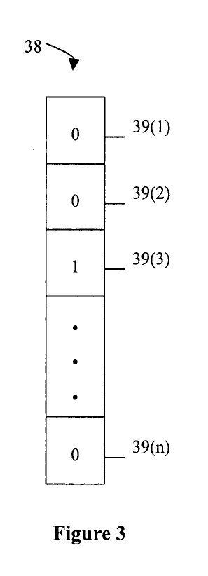

Referring now to FIGS. 1 and 3, an exemplary port status table 38 in accordance to the present invention is provided. The port status table 38 includes a status 39 of the ports having a path to a node 12, wherein a node may be up or down. The term “up” means the port is operational using the pre-configured path wherein the term “down” means the port is not operational using the pre-configured path. In the exemplary embodiment illustrated by FIG. 3, a 0 indicates that the port is up and 1 indicates that the port is down. However, those skilled in the art would recognize that 1 could be used to indicate that the port is up and 0 used to indicate that the port was down. The status is used to derive an index as described below in further detail.

The size of the exemplary port status table 38 is based on the number of ports, n, supported by the node 12. For example, if 32 ports were supported 32 bits would be required. Since each byte has 8 bits the number of bytes for the exemplary port status table 38 would be 4.

In the port status table 38 illustrated in FIG. 3, a status 39(1) indicates that port 1 is up, a status 39(2) indicates that port 2 is up, a status 39(3) indicates that the port 3 is down, and a status 39(n) indicates that the port n is up. The port status table 38 is used in deriving an index corresponding to an LSP.

Now referring to FIGS. 1, 3, and 4, an exemplary improved routing table 42 in accordance to the present invention is provided. The improved routing table 42 includes n number of the incoming routing information 40 and includes n number of the outgoing routing information 44.

The incoming routing information 40 may include an incoming port identifier 22, an incoming internal index 26, and a second port identifier 46. The incoming routing information 40 may further include an incoming index. The outgoing routing information 44 may include an outgoing internal index 36, and an outgoing port identifier 32. The outgoing routing information 44 may further include an outgoing index.

The second port identifier 46 preferably corresponds to the outgoing port that would be used for normal LSP 14; however, the second port identifier may correspond to the outgoing port that would be used for a reroute LSP 16. The second port identifier 46 is used to find a status from the port status table 38, in FIG. 3.

Unlike the routing table 12 in FIG. 2, the incoming internal index 26 in the improved routing table 42 does not provide a direct association to an outgoing internal index 36 in the improved routing table 42. The association is via a derived index as described below in further detail.

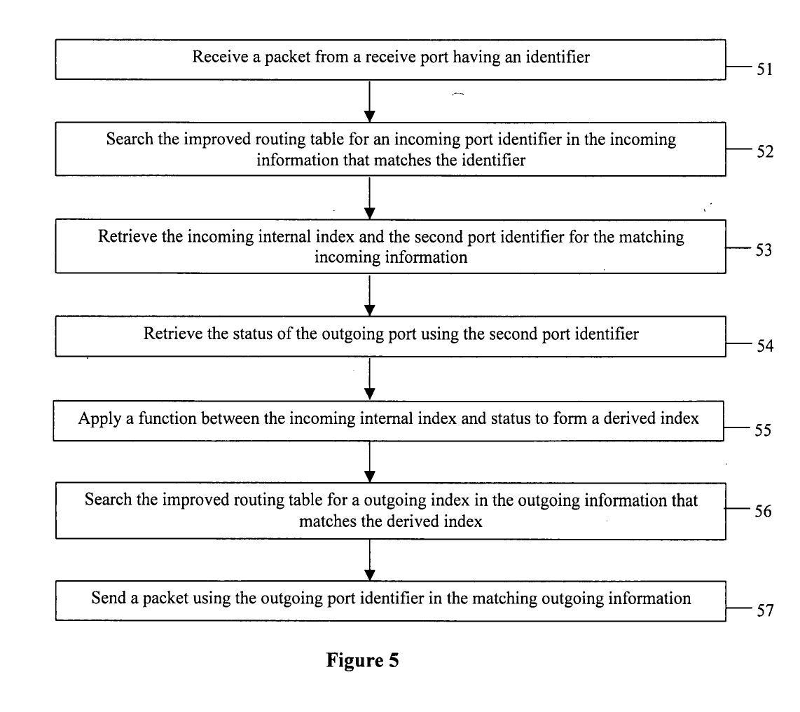

Now referring to FIG. 5, an exemplary flow for fast routing in accordance to the present invention is provided. A packet is received via a receive port having an identifier 51. The identifier is any suitable value that indicates the port on which the packet was received. The improved routing table is searched for the incoming port identifier in the incoming information that matches the identifier 52. The incoming internal index and the second port identifier are retrieved from the matching incoming information 53. A status of the second port identifier is retrieved from the port status table 54. A function is applied between the incoming internal index and status to form a derived index 55. The function may be an operation such as a bitwise OR, bitwise AND, addition, one's complement, and the like. Additionally, the function may be a plurality of the operations. The improved routing table is searched for an outgoing internal index in the outgoing information that matches the derived index 56. A packet is sent using the outgoing port identifier in the matching outgoing information.

For example, referring to FIGS. 1, 3, 4 and 5, if a packet is received on the receive port having an identifier of 1, when the improved routing table 42 is searched for the incoming routing information 40 a match would occur on incoming routing information 40(1). The incoming internal index 26(1) is 200 and the second port identifier 46(1) is 3, which is for this example is the port identifier of the normal LSP 14. A status is retrieved from the port status table 38 for second port identifier 46(1). The status 39(1) for port 1 indicates that the port is up. The status 39(1) ORed to the low order bit of the incoming internal index 26(1) providing a derived index of 200. The derived index is used to find the associated outgoing routing information 44(1) and the outgoing port identifier 32(1), which is 3, is used when sending the packet. Thus a normal LSP 14 is determined.

If however, in the above example the status 39(1) for port 1 indicates that the port is down, the status 39(1) ORed to the low order bit of the incoming internal index 26(1) provides a derived index of 201. The derived index is used to find the associated outgoing routing information 44(2) and the outgoing port identifier 32(2), which is 5, is used when sending the packet. Thus a reroute LSP 16 is determined.

Hence by a function, both the normal LSP 14 and the reroute LSP 16 may be determined. An additional advantage is that the function may be done in approximately 1 μ second, which is a substantial savings in processing over 1/10 second. The indexes 26, 36 should be administered according to the function.

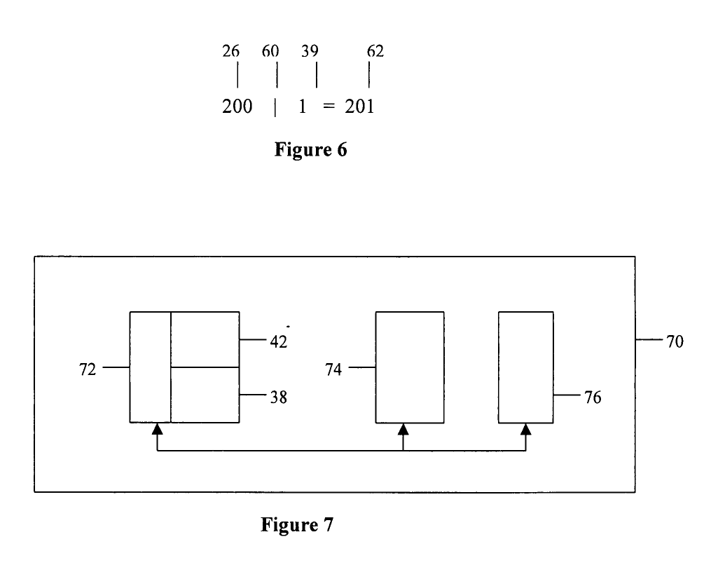

Now referring to FIGS. 6, an exemplary diagram of a calculation of a derived index 54 is provided. A function 54 is applied between the incoming internal index 26 and the status 39 of a port to calculate a derived index 54. In the exemplary example illustrated in FIG. 5, an OR function 54 is applied to the value 200 and the value 1 to calculate the derived index 54 of 201.

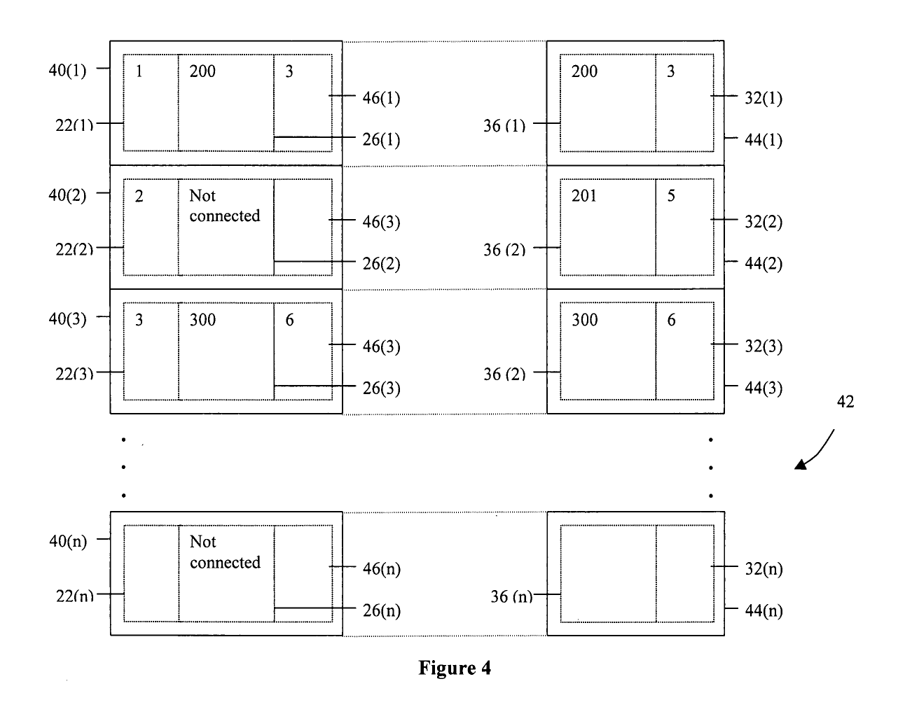

Now referring to FIGS. 4 and 6, an exemplary diagram of a calculation of a derived index 54 is provided. A function 54 is applied between the incoming internal index 26 and the status 39 of a port to calculate a derived index 54. In the exemplary example illustrated in FIG. 5, an bitwise OR function 54 is applied between the low order bit of the value 200 for the incoming internal index 26 and the value 1 of the status 39 to calculate a value 201, which is the derived index 54. Those skilled in the art would appreciate that many different functions may be applied in many different ways. For, example the bitwise OR may be applied between the high order bit of the incoming internal index 26 and the status 39 to calculate the derived index 54.

Referring now to FIG. 7, an exemplary schematic diagram of a device 70 having a fast reroute in accordance with the present invention is provided. The device 70 may be a telephony device having MPLS capabilities, e.g. an LSR, LER, and the like. The device 70 has a memory unit 72 coupled to an incoming mechanism 74 and coupled to a function 76. The term “coupled” refers to any direct or indirect communication between two or more elements in the device 70, whether or not those elements are in physical contact with one another. The device may receive a packet and send a packet.

The memory unit 72 is a hardware unit, such as a Random Access Memory (RAM), a magnetic disk, and the like, which is capable of storing and retrieving information. The memory unit 72 includes the port status table 38 the improved routing table 42. Those skilled in the art would appreciate that status table 38 and the routing table 42 may be in separate memory units 72.

The incoming mechanism 74 provides for
searching the improved routing table 42 for the incoming information 40 having the incoming port 22 that match an identifier associated with a received packet.
retrieving the incoming internal index 26 and the second port identifier 46 for the matching incoming information 40
retrieving the status 39 for the second port identifier 26.

In one embodiment incoming mechanism is software that executes in a processor. In another embodiment the incoming mechanism is hardware, such as an Application Specific Integrated Circuit (ASIC), Field Programmable Gate Array (FPGA), and the like.

The function 76 is applied between the status 39 and the incoming internal index 26 to form a derived index.

Those skilled in the art would recognize that a down status in the port status table 38 may have more than one value if multiple reroute LSPs 16 are used. Additionally, those skilled in the art would recognize that an subsequent field, other than the status 39, could be used when applying the operation, e.g. applying the operation between the subsequent filed and the incoming internal index 26.

While the invention has been described in terms of a certain preferred embodiment and suggested possible modifications thereto, other embodiments and modifications apparent to those of ordinary skill in the art are also within the scope of this invention without departure from the spirit and scope of this invention. Thus, the scope of the invention should be determined based upon the appended claims and their legal equivalents, rather than the specific embodiments described above.

1. A method for finding an Label Switch Path (LSP) in a Multiprotocol Label Switching (MPLS) network device, comprising:
receiving a packet from an receive port having an identifier;
searching an improved routing table having an incoming information and an outgoing information for the incoming information having an incoming port identifier that matches the identifier;
retrieving the incoming internal index and the second port identifier from the matching incoming information;
retrieving a status for the second port identifier from a port status table; and
applying a function between the incoming internal index and status forming a derived index.

2. The method according to claim 1, further comprising using the derived index to find an outgoing information having a outgoing internal index that matches the derived index.

3. The method according to claim 2, wherein the outgoing information has an outgoing port identifier for a normal LSP or a reroute LSP

4. The method according to claim 3, further comprising sending a packet using the outgoing port identifier.

5. The method according to claim 1, wherein the port status table is a bit vector.

6. The method according to claim 1, wherein the fimction is a bitwise OR of the port status with the low order bit of the incoming internal index.

7. The method according to claim 1, wherein the function is a bitwise OR of the port status with the high order bit of the incoming internal index.

8. The method according to claim 1, wherein the function is addition of the port status with the low order bit of the incoming internal index.

9. A device in a Multiprotocol Label Switching (MPLS) network device having a fast reroute, comprising:
a first memory unit;
an improved routing table stored in the first memory unit comprising:
an incoming information including a first port identifier, an incoming internal index, and a second port identifier, and
an outgoing information including an outgoing internal index, and a third port identifier;
a port status table having a status in the first memory unit;
an incoming port, which has an identifier, receiving a packet;
an incoming mechanism operable to:
search the improved routing table for the incoming information having the incoming port that matches the identifier,
retrieve the incoming internal index and the second port identifier for the matching incoming information, and
retrieve the status for the second port identifier; and
an function applied between the incoming internal index and status forming a derived index.

10. The device according to claim 9, wherein the operator is a bitwise OR applied to the low order bits of the incoming internal index.

11. The device according to claim 9, wherein the operator is a bitwise OR applied to the high order bits of the incoming internal index.

12. The device according to claim 9, wherein the derived index is used to find an outgoing information, and the third port identifier is used to send a packet.

13. The device according to claim 12, wherein the device is a Label Switch Router or a Label Edge Router.

14. The device according to claim 13, further comprises a processor to execute software having the incoming mechanism.

15. The device according to claim 13, further comprises an Application Specific Integrated Circuit or a Field Programmable Gate Array having the incoming mechanism.

16. The device according to claim 9, wherein the port status table is a bit vector.

17. The device according to claim 9, the port status table is in a second memory unit.
